(19) United States
(12) Patent Application Publication
(10) Pub. No.: US 2018/0198239 A1
(43) Pub. Date: Jul. 12, 2018

(54) SIGNAL TERMINAL SET WITH COMPENSATED STRUCTURE

(71) Applicant: KINSUN INDUSTRIES INC., Taoyuan City (TW)

(72) Inventors: Ching-Neng KAN, Taoyuan City (TW); Li-Ju HSU, Taoyuan City (TW); Shu-Hung HSIAO, Taoyuan City (TW)

(21) Appl. No.: 15/729,642

(22) Filed: Oct. 10, 2017

(30) Foreign Application Priority Data
Jan. 6, 2017 (TW) 106100409

(51) Int. Cl. H01R 13/6467; H01R 43/24; H01R 13/6464

(52) U.S. Cl. CPC H01R 13/6467; H01R 13/6464; H01R 43/24

(57) ABSTRACT

A signal terminal set includes a first material strip including a first connecting plate and a plurality of first signal terminals connected in parallel to the first connection plate and providing a respective bridging segment, and a second material strip including a second connecting plate attached onto the first connection plate and a plurality of second signal terminals connected in parallel to the second connection plate and providing a respective travel segment to create with the bridging segments of the first signal terminals a compensated structure, simplifying the manufacturing process and increasing the yield.

### BACKGROUND OF THE INVENTION

### 1. Field of the Invention

The present invention relates to electrical connector technology and more particularly, to a signal terminal set for electrical connector, which has first signal terminals and second signal terminals respectively formed on a first material strip and a second material strip and so configured that the first signal terminals and the second signal terminals are set to create a compensated structure when the first material strip and the second material strip are arranged in a stack, simplifying the manufacturing process, increasing the yield and reducing the manufacturing cost.

### 2. Description of the Related Art

A signal terminal set for electrical connector generally comprises two sets of signal terminals. In order to avoid crosstalk interference between the two sets of signal terminals, signal terminal sets with compensated structure are designed. In the compensated structure, the signal terminals of one set bridge over the signal terminals of the other set without contact to produce a capacitive effect, reducing crosstalk interference. In this prior art design, the vertical projections of the two sets of signal terminals are overlapped. In order to eliminate this problem, the two sets of signal terminals that are connected to respective material strips are differently curved so that one set of signal terminals can cross over the other set of signal terminals. However, this measure is complicated. For small size application, the fabrication of this design of signal terminal set is more difficult, resulting in reduced yield.

### SUMMARY OF THE INVENTION

The present invention has been accomplished under the circumstances in view. It is therefore the main object of the present invention to provide a signal terminal set, which employs an alignment measure to keep a first material strip and a second material strip thereof in a stack so that the first signal terminals of the first material strip and second signal terminals of the second material strip are arranged to create a compensated structure, simplifying the manufacturing process and increasing the yield.

To achieve this and other objects of the present invention, a signal terminal set comprises a first material strip and a second material strip. The first material strip comprises a first connection plate, and a plurality of first signal terminals connected to the first connection plate. Each first signal terminal comprises a first bridging segment, a first mating connection segment extended from one end of the first bridging segment and connected to the first connection plate, and a first bonding segment extended from an opposite end of the first bridging segment. The second material strip comprises a second connection plate, and a plurality of second signal terminals connected to the second connection plate. Each second signal terminal comprises a first travel segment, a second mating connection segment extended from one end of the first travel segment and connected to the second connection plate, and a second bonding segment extended from an opposite end of the first travel segment. The first connection plate and the second connection plate are arranged in a stack to keep the first mating connection segments in parallel to the second mating connection segments and the first bonding segments in parallel to the second bonding segments, so that the first bridging segments bridge over the respective first travel segments with no contact therebetween to create a compensated structure.

### BRIEF DESCRIPTION OF THE DRAWINGS

FIG. 1 is an exploded view of a signal terminal set in accordance with a first embodiment of the present invention.

FIG. 2 illustrates the first material strip and second material strip of the signal terminal set of the first embodiment of the present invention arrange in a stack.

FIG. 3 is an enlarged view of Part A of FIG. 2.

FIG. 4 is an exploded view of a signal terminal set in accordance with a second embodiment of the present invention.

FIG. 5 illustrates the first material strip and second material strip of the signal terminal set of the second embodiment of the present invention arrange in a stack.

FIG. 6 is an exploded view of a signal terminal set in accordance with a third embodiment of the present invention.

FIG. 7 illustrates the first material strip and second material strip of the signal terminal set of the third embodiment of the present invention arrange in a stack.

FIG. 8 is an enlarged view of Part B of FIG. 7.

FIG. 9 is an applied view of the present invention, illustrating the signal terminal set of the third embodiment installed in an electrically insulative housing (I).

FIG. 10 is an applied view of the present invention, illustrating the signal terminal set of the third embodiment installed in an electrically insulative housing (II).

FIG. 11 is an applied view of the present invention, illustrating the signal terminal set of the third embodiment installed in an electrically insulative housing (III).

FIG. 12 is an applied view of the present invention, illustrating the signal terminal set of the third embodiment installed in an electrically insulative housing (IV).

### DETAILED DESCRIPTION OF THE PREFERRED EMBODIMENT

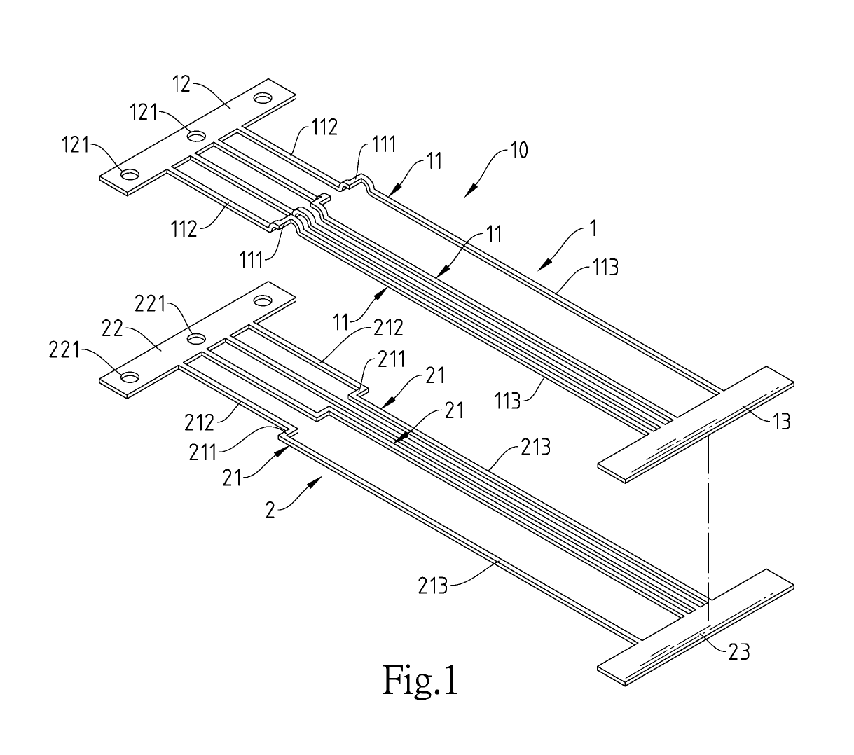

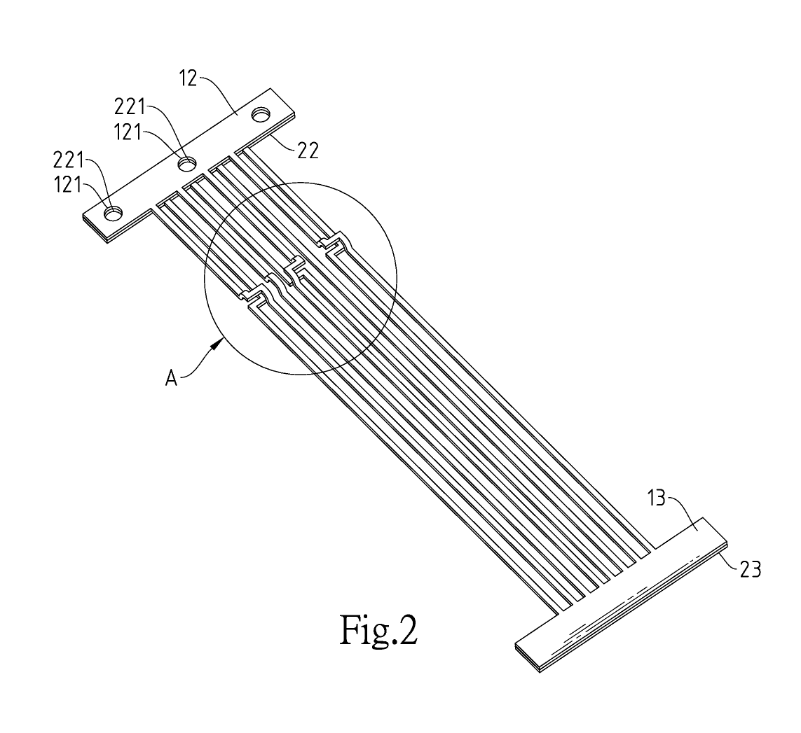

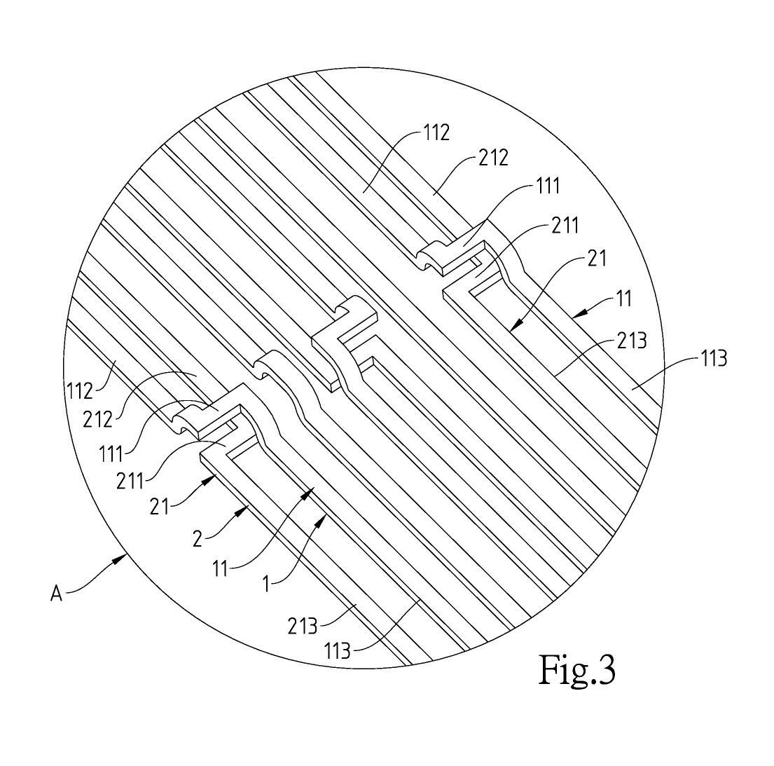

Referring to FIGS. 1-3, a signal terminal set 10 in accordance with a first embodiment of the present invention generally comprises a first material strip 1 and a second material strip 2.

The first material strip 1 comprises a plurality of first signal terminals 11 arranged in parallel, a first connection plate 12 integrally connected with respective one ends of the first signal terminals 11, and a first positioning plate 13 integrally connected with respective opposite ends of the first signal terminals 11. Each first signal terminal 11 comprises a substantially arched first bridging segment 111 that curves sideways, a first mating connection segment 112 connected between one end of the first bridging segment 111 and the first connection plate 12, and a first bonding segment 113 connected between an opposite end of the first bridging segment 111 and the first positioning plate 13. Further, the first connection plate 12 is configured to provide a plurality of first positioning holes 121.

The second material strip 2 comprises a plurality of second signal terminals 21 arranged in parallel, a second connection plate 22 integrally connected with respective one ends of the second signal terminals 21, and a second positioning plate 23 integrally connected with respective opposite ends of the second signal terminals 21. Each second signal terminal 21 comprises a first travel segment 211 extending in a parallel manner relative to the second connection plate 22 and the second positioning plate 23, a second mating connection segment 212 connected between one end of the first travel segment 211 and the second connection plate 22, and a second bonding segment 213 connected between an opposite end of the first travel segment 211 and the second positioning plate 23. Further, the second connection plate 22 is configured to provide a plurality of second positioning holes 221.

In application, the first material strip 1 is attached onto the second material strip 2 in a stack to keep the first positioning holes 121 of the first connection plate 12 in alignment with the respective second positioning hole 221 of the second connection plate 22, and then pins (not shown) are respectively inserted through the first positioning holes 121 and the respective second positioning holes 221 to hold the first connection plate 12 and the second connection plate 22 together. Since the first bridging segments 111 and the first travel segments 211 are curved in reversed directions, the first mating connection segments 112 and the second mating connection segment 212 exhibit a parallel relationship, the first bonding segments 113 and the second bonding segment 213 also exhibit a parallel relationship, the first bridging segments 111 bridge over the respective first travel segments 211 without contact, creating a compensated structure. In this embodiment, the first bridging segments 111 and the first travel segments 211 are curved in reversed directions so that the first bonding segments 113 of the first signal terminals 11 are respectively disposed at one lateral side relative to the respective second mating connection segments 212 of the respective second signal terminals 21; the second bonding segments 213 of the second signal terminals 21 are respectively disposed at one lateral side relative to the respective first mating connection segments 112 of the respective first signal terminals 11, i.e., the arrangement of the first mating connection segments 112 and the second mating connection segments 212 is different from the arrangement of the first bonding segments 113 and the second bonding segments 213.

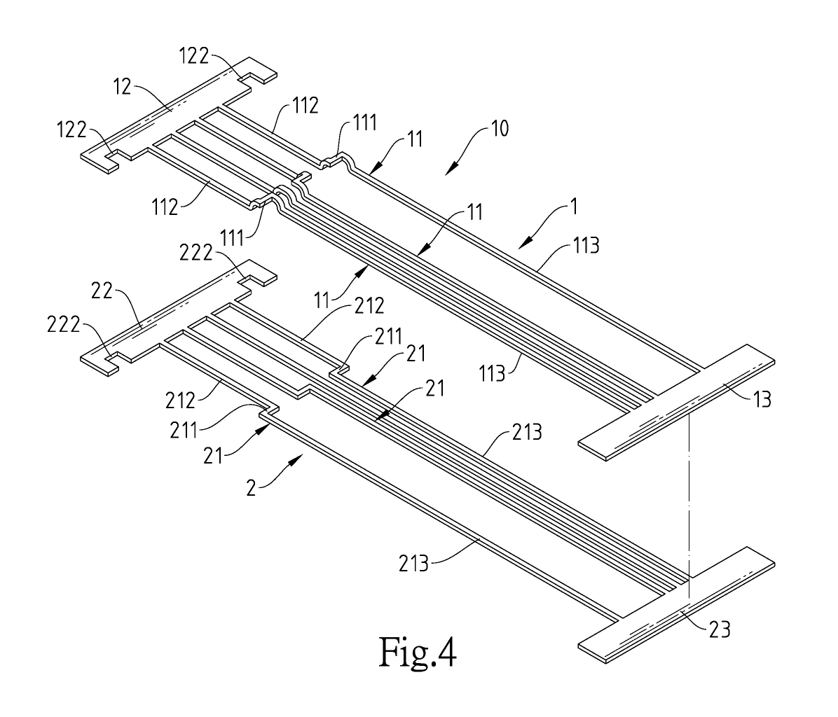

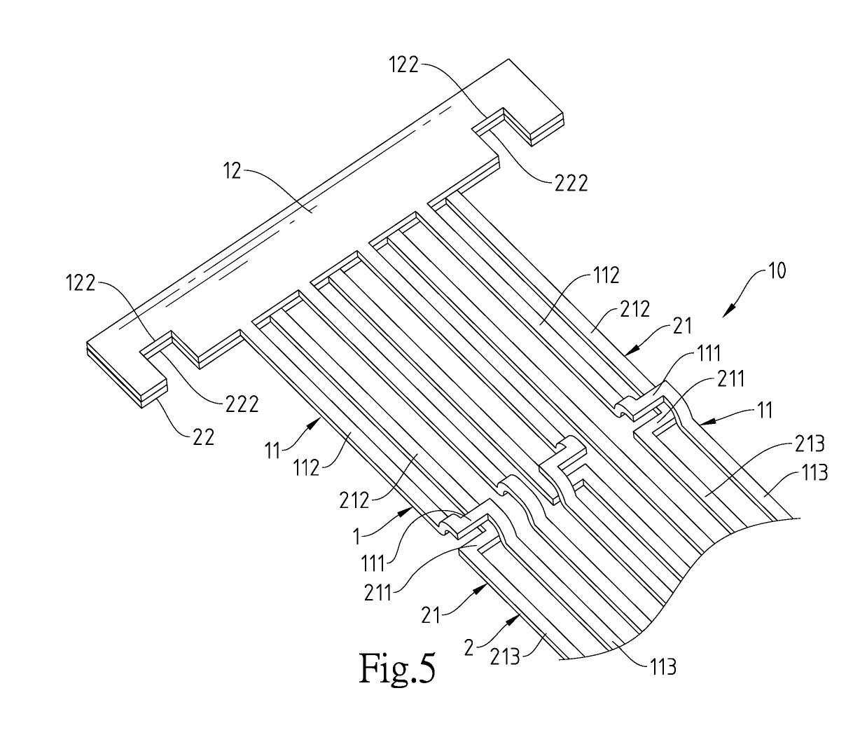

Referring to FIGS. 4 and 5, a signal terminal set 10 in accordance with a second embodiment of the present invention is shown. This second embodiment is substantially similar to the aforesaid first embodiment with the exception that the first connection plate 12 is configured to provide a plurality of first positioning notches 22 instead of the aforesaid first positioning holes 121; the second connection plate 22 is configured to provide a plurality of second positioning notches 22 instead of the aforesaid second positioning holes 221. When the first connection plate 12 and the second connection plate 22 stacked up, pins (not shown) are respectively inserted into the first positioning notches 122 and the respective second positioning notches 222 to hold the first connection plate 12 and the second connection plate 22 together.

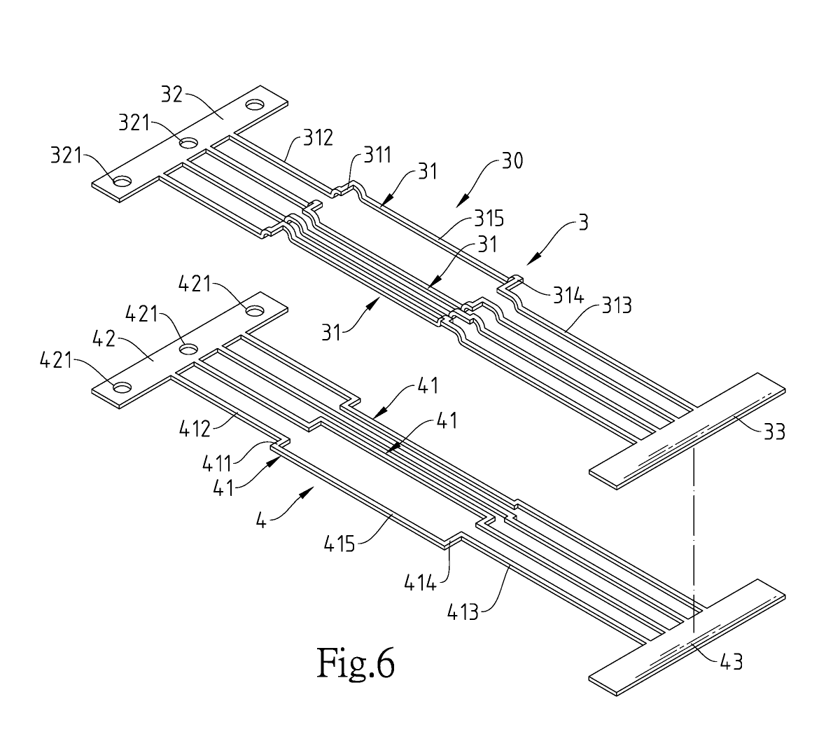

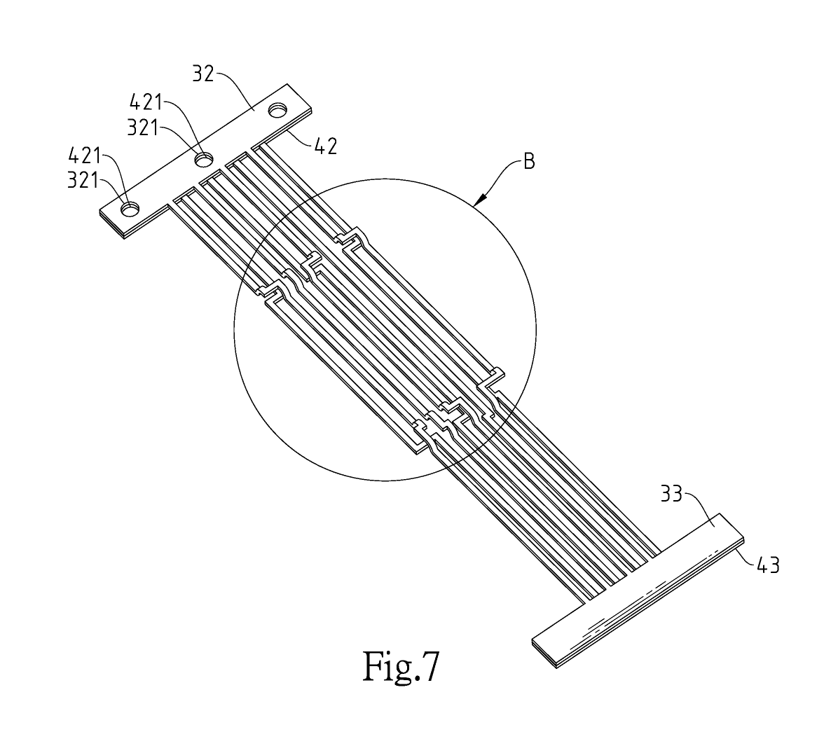

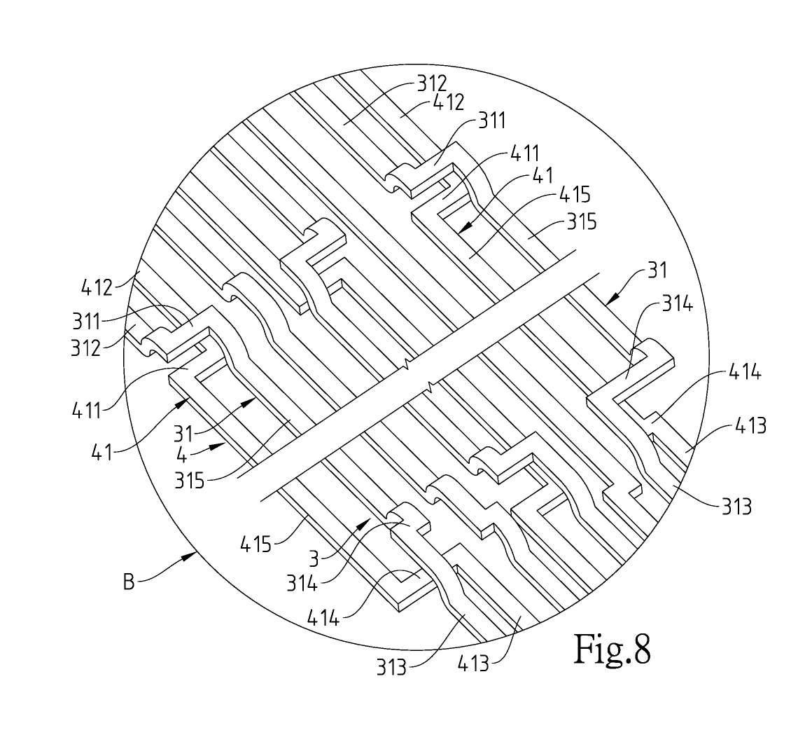

Referring to FIGS. 6-8, a signal terminal set 30 in accordance with a third embodiment of the present invention is shown. This third embodiment is substantially similar to the aforesaid first embodiment with the exceptions outlined hereinafter. The signal terminal set 30 comprises a first material strip 3 and a second material strip 4. The first material strip 3 comprises a first connection plate 32 with first positioning holes 321, a first positioning plate 33, and a plurality of first signal terminals 31 integrally connected between the first connection plate 32 and the first positioning plate 13. Each first signal terminal 31 comprises a first bridging segment 311, a second bridging segment 314, a first extension segment 315 connected between the first bridging segment 311 and the second bridging segment 314, a first mating connection segment 312 connected between the first bridging segment 311 and the first connection plate 32, and a first bonding segment 313 connected between the second bridging segment 314 and the first positioning plate 33. The second material strip 4 comprises a second connection plate 42 with second positioning holes 421, a second positioning plate 43, and a plurality of second signal terminals 41 connected between the second connection plate 42 and the second positioning plate 43. Each second signal terminal 41 comprises a first travel segment 411, a second travel segment 414, a second extension segment 415 connected between the first travel segment 411 and the second travel segment 414, a second mating connection segment 412 connected between the first travel segment 411 and the second connection plate 42, and a second bonding segment 413 connected between the second travel segment 414 and the second positioning plate 43.

When the first connection plate 32 of the first material strip 3 is stacked up with the second connection plate 42 of the second material strip 4, the first bridging segments 311 bridge over the respective first travel segments 411 without contact to create a compensated structure, the second bridging segments 314 bridge over the respective second travel segments 414 without contact to create another compensated structure, i.e., this third embodiment creates two compensated structures, enhancing the effect of eliminating crosstalk. Since the curving direction of the first bridging segment 311 and second bridging segment 314 is reversed to the curving direction of the first travel segment 411 and the second travel segment 414, the first bonding segments 313 of the first signal terminals 31 are not disposed in axial alignment with the respective first mating connection segments 312; the second bonding segments 413 of the second signal terminals 41 are not disposed in axial alignment with the respective second mating connection segments 412; the first extension segments 315 of the first signal terminals 31 are respectively disposed between the second bonding segments 413 and second mating connection segments 412 of the second signal terminals 41; the second extension segments 415 of the second signal terminals 41 are respectively disposed between the first bonding segments 313 and first mating connection segments 312 of the first signal terminals 31, i.e., the arrangement of the first mating connection segments 312 and second mating connection segment 412 is same as the arrangement of the first bonding segments 313 and second bonding segments 413.

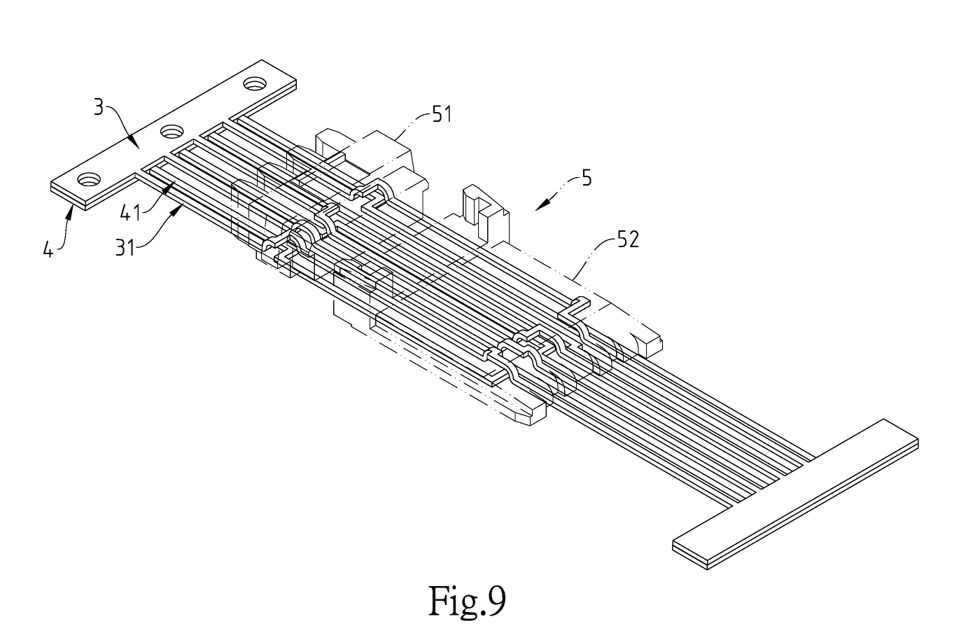

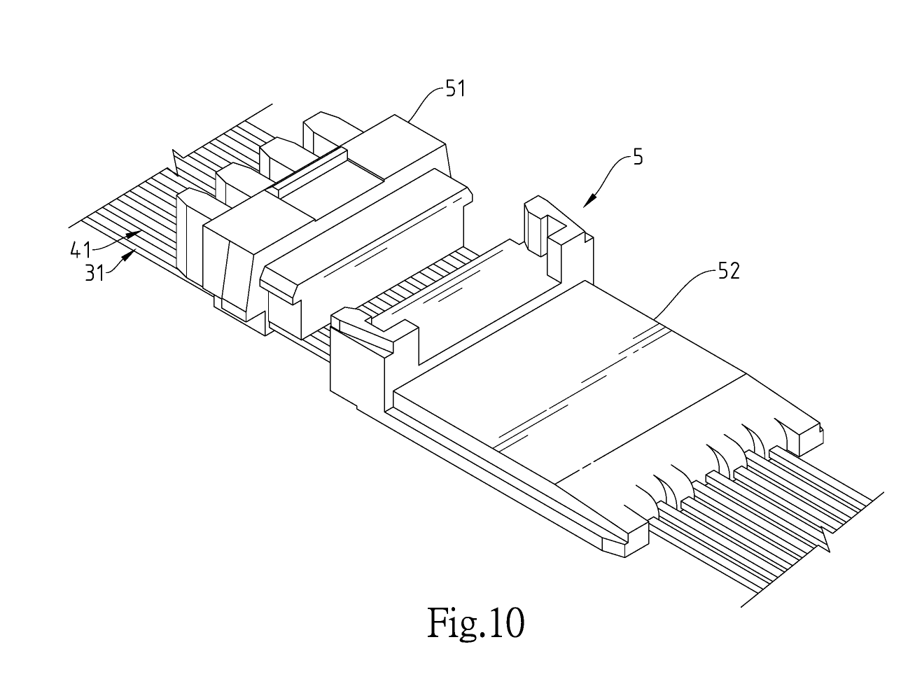

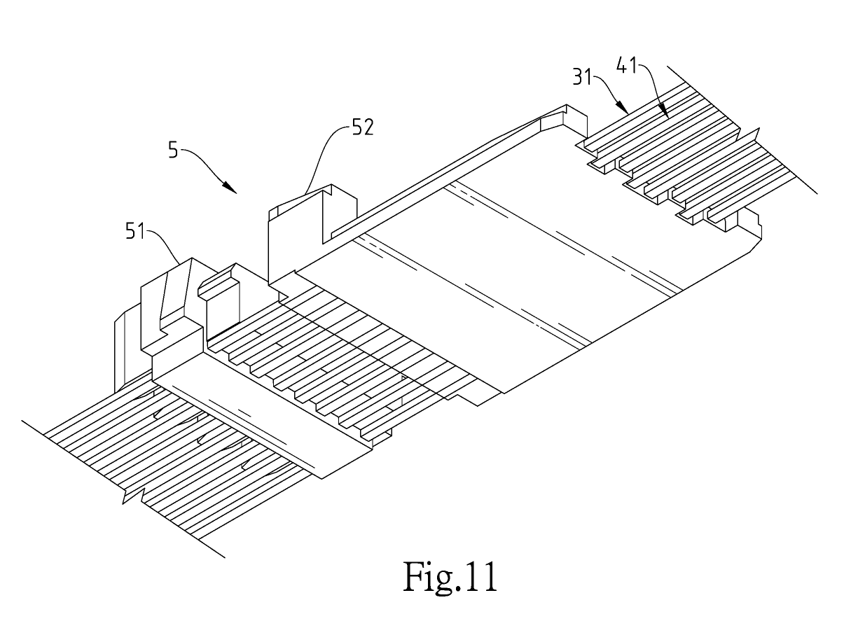

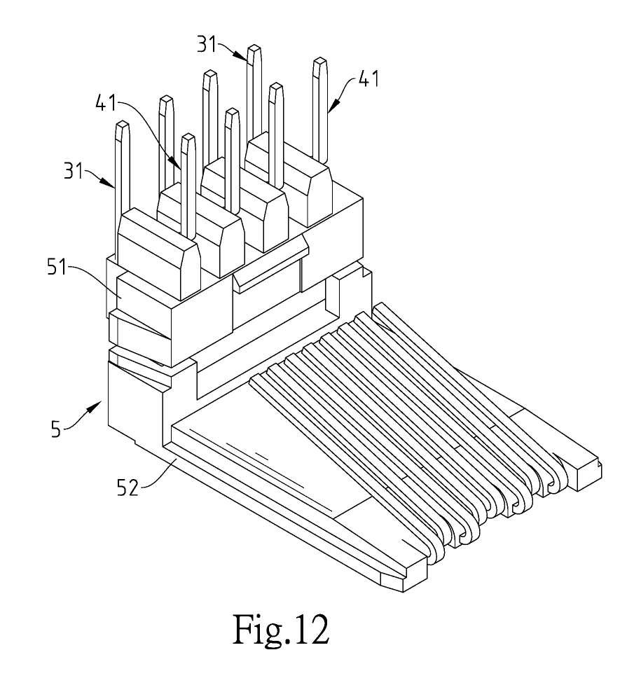

Referring to FIGS. 6-12, when using the signal terminal set 30 to make an electrical connector, hold down the first mating connection segments 312 of the first signal terminals 31 and the second mating connection segments 412 of the second signal terminals 41 on one same plane, and also hold down the first bonding segments 313 of the first signal terminals 31 and the second bonding segments 413 of the second signal terminals 41 on one same plane, and then wrap a first terminal holder block 51 and a second terminal holder block 52 of an electrically insulative housing 5 about the compensated structure of the first bridging segment 311 and first travel segment 411 and the compensated structure of the second bridging segment 314 and second travel segment 414 using insert molding technology, and then bend the first extension segments 315 and the second extension segment 415 to move the first terminal holder block 51 into connection with the second terminal holder block 52.

What the invention claimed is:

1. A signal terminal set, comprising:
a first material strip comprising a first connection plate and a plurality of first signal terminals connected to said first connection plate, each said first signal terminal comprising a first bridging segment, a first mating connection segment extended from one end of said first bridging segment and connected to said first connection plate and a first bonding segment extended from an opposite end of said first bridging segment; and
a second material strip comprising a second connection plate and a plurality of second signal terminals connected to said second connection plate, each said second signal terminal comprising a first travel segment, a second mating connection segment extended from one end of said first travel segment and connected to said second connection plate and a second bonding segment extended from an opposite end of said first travel segment;
wherein said first connection plate and said second connection plate are arranged in a stack to keep said first mating connection segments in parallel to said second mating connection segments and said first bonding segments in parallel to said second bonding segments, so that said first bridging segments bridge over the respective said first travel segments with no contact therebetween to create a compensated structure.

2. The signal terminal set as claimed in claim 1, wherein said first signal terminals of said first material strip are arranged in parallel; said second signal terminals of said second material strip are arranged in parallel.

3. The signal terminal set as claimed in claim 1, wherein said first bridging segments of said first signal terminals and said first travel segments of said second signal terminals are curved sideways in reversed directions, so that said first bonding segments of said first signal terminals are respectively disposed at one lateral side relative to the respective said second mating connection segments of said second signal terminals; said second bonding segments of said second signal terminals are respectively disposed at one lateral side relative to the respective said first mating connection segments of said first signal terminals.

4. The signal terminal set as claimed in claim 1, wherein each said first signal terminal of said first material strip further comprises a second bridging segment and a first extension segment connected between said first bridging segment and said second bridging segment; said first mating connection segment is connected to one end of said first bridging segment remote from said first extension segment; said first bonding segment is connected to one end of said second bridging segment remote from said first extension segment; each said second signal terminal of said second material strip further comprises a second travel segment and a second extension segment connected between said first travel segment and said second travel segment; said second mating connection segment is connected to one end of said first travel segment remote from said second extension segment; said second bonding segment is connected to one end of said second travel segment remote from said second extension segment; said first connection plate of said first material strip is stacked up with said second connection plate of said second material strip to keep said first extension segments and said second extension segments in parallel, so that said second bridging segments bridge over the respective said second travel segment with no contact therebetween to create a compensated structure.

5. The signal terminal set as claimed in claim 4, wherein said first bridging segments and said second bridging segments of said first signal terminals are respective curved sideways; said first travel segments and said second travel segments of said second signal terminals are respectively curved sideways in a reversed manner relative to the sideway curving direction of said first bridging segments and said second bridging segments of said first signal terminals so that said first bonding segments of said first signal terminals and said first mating connection segments are disposed in an offset relationship; said second bonding segments of said second signal terminals and said second mating connection segments are disposed in an offset relationship; said first extension segments of said first signal terminals are disposed between the respective said second bonding segments and said second mating connection segments of said second signal terminals; said second extension segments of said second signal terminals are respectively disposed between the respective said first bonding segments and said first mating connection segments of said first signal terminals.

6. The signal terminal set as claimed in claim 1, wherein said first connection plate of said first material strip comprises a plurality of first positioning holes; said second connection plate of said second material strip comprises a plurality of second positioning holes that are respectively kept in axial alignment with the respective said first positioning holes when said first connection plate and said second connection plate are arranged in a stack.

7. The signal terminal set as claimed in claim 1, wherein said first connection plate of said first material strip comprises a plurality of first positioning notches; said second connection plate of said second material strip comprises a plurality of second positioning notches that are respectively kept in alignment with the respective said first positioning notches when said first connection plate and said second connection plate are arranged in a stack.
